(19) United States
(12) Patent Application Publication
(10) Pub. No.: US 2005/0276430 A1
(43) Pub. Date: Dec. 15, 2005

(54) Fast headphone virtualization

(75) Inventors: Chao He, Bothell, WA (US); Wei-Ge Chen, Issaquah, WA (US)

Correspondence Address: KLARQUIST SPARKMAN LLP, 121 S.W. SALMON STREET, SUITE 1600, PORTLAND, OR, 97204, US

(73) Assignee: Microsoft Corporation, Redmond, WA (US)

(21) Appl. No.: 10/857,038

(22) Filed: May 28, 2004

(51) Int. Cl. H04R 5/02; H04R 5/00

(52) U.S. Cl. 381/309; 381/310; 381/17

(57) ABSTRACT

Fast headphone virtualization techniques reduces the computational expense of providing multi-channel audio virtualization (which may also include reflection and reverberation effects) on headphones. First, the number of inverse Fast Fourier Transforms (FFT) involved in an FFT-based FIR filter headphone virtualization approach is reduced by summing the contributions of N-channels in the frequency domain prior to the inverse FFT. Second, the reverberation part of a room filter is implemented as a hybrid FIR/IIR filter, where subsequent filter segments are approximated by successively scaling the result of an initial reverberation filter segment. Third, a low pass filter is added in the hybrid FIR/IIR filter to provide warmth control.

### TECHNICAL FIELD

The invention relates generally to digital signal processing of multi-channel audio signals.

### BACKGROUND

Multi-channel audio can provide a much richer and more enjoyable listening experience. Multi-channel audio is usually delivered by a surround sound system with multiple speakers, such as is currently available in some movie theater sound systems, DVD players, and home theater entertainment systems. Several modem multi-channel audio codecs, such as Windows Media Audio Professional (WMA Pro), also support multi-channel audio on personal computers, and etc. Because the sound is delivered from multiple speakers at different locations in these surround sound environments, the listeners perceive the sound coming from different directions with certain distances.

But under some circumstances when a surround sound system is not available (such as on portable audio players, and in-flight audio systems) or it is not preferred (such as at night or in office settings), the multi-channel audio has to be delivered through a normal stereo headphone. Through use of simple fold down or other similar methods to convert multi-channel audio to stereo, multi-channel audio sources can be delivered through the headphone directly. But, the appealing sensation of direction and distance are lost. The listener instead perceives the sound as coming from positions on a straight line connecting his or her left ear and right ear. It would be desirable therefore to also provide the headphone listener with a surround sound listening experience. Such a feature is a significant complement of the surround sound system.

Fortunately, with a certain kind of signal processing, the perception of both direction and distance of sound available from a surround sound environment can be mimicked on headphones. Headphone virtualization is a digital signal processing (DSP) technology which can deliver multi-channel audio source through normal stereo headphone and give listeners the realistic listening experience of a surround sound environment. It can also work with stereo or mono audio source and make them sound more natural. The theory behind it is called auralization. (See, e.g., H. Moller, “Fundamentals of Binaural Technology”, Applied Acoustics 36, pp. 171-218, 1992.)

In a surround sound environment, each speaker's audio output will reach both ears of the listener. The listener experiences the directional and external sound perception from differences in the sound output arriving from each speaker at both ears. Auralization attempts to create two audio inputs that mimic the audio arriving from the multiple speakers of a multi-channel audio system at the listener's ears, and delivers these audio inputs directly into the listener's ears through the headphone. In this way, the listener should have a simulated “surround sound” listening experience similar to listening in a real surround sound environment.

FIG. 1 shows the basic diagram of an auralization system. In the diagram, H represents the transform function from the output of the speaker to the input of the ear. It is assumed to be a time-invariant linear filter, and is often termed a Head-Related Transfer Function (HRTF). Representative HRTF functions have been measured by several research groups, as described by, e.g., Bill Gardner and Keith Martin, “HRTF Measurements of a KEMAR Dummy-Head Microphone,” MIT Media Lab Perceptual Computing—Technical Report #280, May 1994; and R. Algazi, R. O. Duda, D. M. Thompson and C. Avendano, “The CIPIC HRTF Database,” Proc. 2001 IEEE Workshop on Applications of Signal Processing to Audio and Electroacoustics, pp. 99-102, Mohonk Mountain House, New Paltz, N.Y., Oct. 21-24, 2001. The measured HRTF usually only includes direct sound which is the sound coming from the speaker directly. For better externalization effect and more natural listening experience, early reflection and reverberation could be added to the H filter. The term room filter is sometimes used to designate such a general H filter that includes direct sound, early reflection, and reverberation. The H filter can be implemented as a long FIR filter using the Fast Fourier Transform (FFT) approach described by Alan V. Oppenheim, Ronald W. Schafer and John R. Buck, “Discrete-Time Signal Processing”, 2^{nd} edition, pp. 582-588, Prentice-Hall New Jersey, 1999.

Unfortunately, the conventional auralization DSP technique has been so computationally expensive as to be impractical in most commercial applications. Due to the length of FIR filters, the required computation to directly implement the HRTF as FIR filters has been prohibitive for a long time. More specifically, the measured HRTF described in the above-cited references is already hundreds of taps long. With the early reflection and reverberation included the H filter could be thousands of taps long to represent a normal room. In a worst case example, a typical theater “room” could have reverberation longer than 1 second. If the sampling rate is 48000 Hz, the room filter would be longer than 48000 taps. Further, a system to deliver a 5.1 multi-channel audio source using conventional auralization needs 10 such filters (the low frequency channel could be skipped). As a result, a lot of research has been done on using IIR filters to approximate the original FIR room filters. But, the accuracy of the auralization is sacrificed. Recently, with the dramatic increase in computational power of the modem central process unit (CPU) and availability of more advanced instruction sets, the direct FIR implementation of auralization has become possible. However, the computational expense of the conventional auralization remains an impediment to commercially feasible and inexpensive headphone-based surround sound systems.

### SUMMARY

Techniques for fast headphone virtualization are described herein. These techniques reduce the computational expense of providing multi-channel audio virtualization (which may also include reflection and reverberation effects) on headphones, making such headphone virtualization practical in more applications (such as applications using less expensive signal processing units otherwise incapable of conventional headphone virtualization, or applications consuming a lower computational load on signal processors otherwise capable of full conventional headphone virtualization).

In accordance with a first fast headphone virtualization technique, the 2N transform functions (H) applied to the N-channels of a multi-channel audio signal to produce left/right headphone audio inputs are implemented as FIR filters using an FFT-based approach. The first fast headphone virtualization technique reduces the number of inverse FFT transforms of the FFT-based FIR filters by summing contributions from the N-channels to the respective left or right headphone audio input in the transform domain, prior to inverse FFT transform. The reduces the number of inverse FFT transforms that produce each headphone audio input from N to one.

A second fast headphone virtualization technique uses a hybrid FIR/IIR filter to provide a fast room filter implementation with very long reverberation. In this hybrid approach, direct sound and early reflection from each channel to the ear is modeled by HRTF filters. A reverb portion of the room filter is partitioned into segments. Further, segments subsequent to a first reverb segment are approximated by scaling the reverb signal resulting from the immediately prior segment by a constant value. A same constant value can be applied successively to the subsequent segments to further reduce the computational expense.

A third fast headphone virtualization technique provides warmth control for varying warmth of the reverberation. The reverberation at high and low frequencies decay at different rates. (The reverberation at high frequencies decays faster than low frequencies.) In the third fast headphone virtualization technique, a different rate of decay is provided by inserting a low pass filter in the computation of successive reverberation segments. The frequency response of this low pass filter can be tuned to control the perceived “warmth” of the reverberation.

Additional features and advantages of the invention will be made apparent from the following detailed description of embodiments that proceeds with reference to the accompanying drawings.

### BRIEF DESCRIPTION OF THE DRAWINGS

FIG. 1 is a basic block diagram depicting the auralization digital signal processing technique of the prior art.

FIG. 2 is a block diagram of an audio system implementing fast headphone virtualization techniques described herein.

FIG. 3 is a block diagram of an overlap-add headphone virtualization technique.

FIG. 4 is a block diagram of a block convolution headphone virtualization technique.

FIG. 5 is a block diagram of a technique for fast headphone virtualization in the audio system of FIG. 2.

FIG. 6 is a graph depicting a typical room filter.

FIG. 7 is a block diagram of a hybrid FIR/IIR approach for fast headphone virtualization in the audio system of FIG. 2.

FIG. 8 is a block diagram of a complete n-channel to one-channel system using the hybrid FIR/IIR approach of FIG. 7 for fast headphone virtualization in the audio system of FIG. 2.

FIG. 9 is a block diagram of the n-channel to one-channel system of FIG. 8 further including post-reverb.

FIG. 10 is a block diagram of the hybrid FIR/IIR approach of FIG. 7 with warmth control.

FIG. 11 is a block diagram of a suitable computing environment for implementing the audio system with fast headphone virtualization of FIG. 2.

### DETAILED DESCRIPTION

The following description is directed to techniques for fast headphone virtualization, which provides a computationally efficient surround-sound effect when playing a multi-channel audio signal source on stereo headphones.

1. Illustrated Embodiment

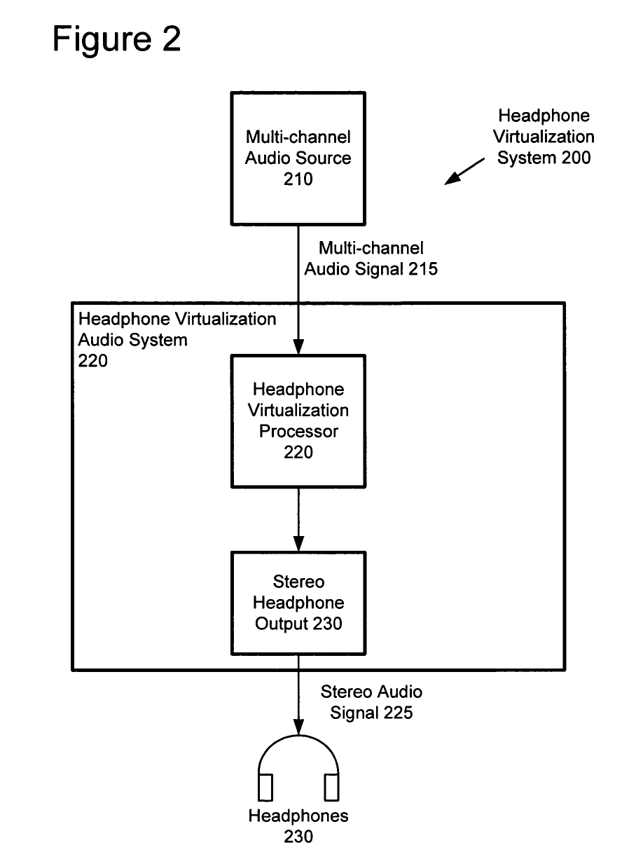

With reference to FIG. 2, the description presents an exemplary application of this technique in a headphone virtualization audio system 200 for playing an n-channel audio signal 215 on headphones 240 In this example of a headphone virtualization system 200, a multi-channel audio signal 215 is obtained from a multi-channel audio source 210, which may be a DVD player, surround-sound receiver, multi-channel audio format (e.g., super audio-CD (SACD) and like) CD player, a multi-channel digital audio stream (e.g., in a multi-channel Windows Media Audio (WMA) or other multi-channel digital audio format), or other multi-channel audio signal source. The multi-channel audio source 210 can be an external source, or internally integrated in the audio system 200. A headphone virtualization processor 220 processes this multi-channel audio signal 215 to produce a two-channel, left/right audio signal 225, which is provided to a set of connected headphones 240 from a stereo headphone output 230. The headphone virtualization processor 220 applies fast headphone virtualization techniques described herein to efficiently produce the two channel audio signal with a virtual surround sound effects from the multi-channel audio signal 215. In various applications, the headphone virtualization processor 220 can be implemented using a digital signal processor or more generally a central processing unit (CPU) programmed to perform the signal processing techniques described herein. The stereo headphone output 230 can be implemented using a suitable stereo audio amplifier and headphone jack or connector, as is conventionally known.

2. Auralization Overview

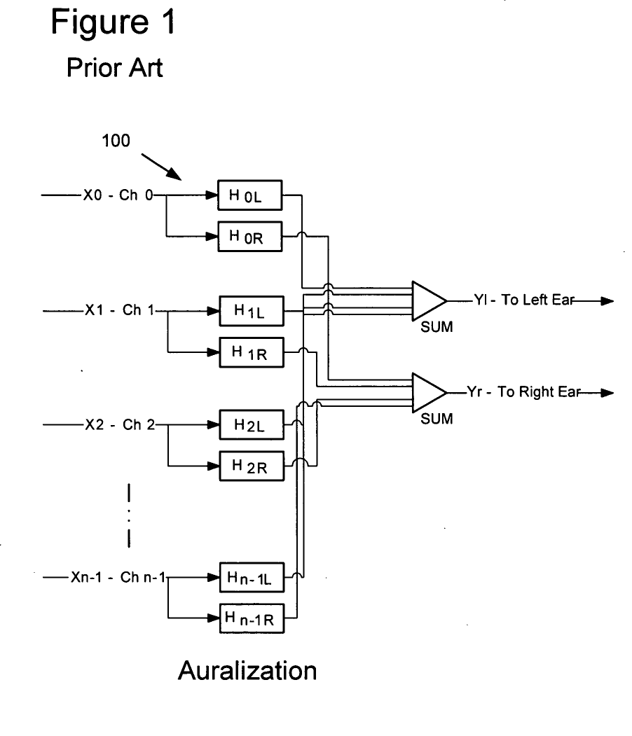

In conventional auralization shown in FIG. 1, the relationship between the outputs (i.e., left and right headphone inputs Yₗ and Yᵣ) and the inputs (i.e., N-audio signal channels Xᵢ, 0≦i≦(N−1)) is:

$$Yl = {\sum }_{i = 0}^{N - 1} Xi ⊗ {H}_{iL}$$

$$Yr = {\sum }_{i = 0}^{N - 1} Xi ⊗ {H}_{iR}$$

where H_{iL} and H_{iR} are head-related transform functions between the respective channel inputs Xᵢ and each of the two outputs Yₗ and Yᵣ. Basically, this forms two N-input to 1-output (N-to-1) systems.

A basic N-to-1 system implementation of this relationship is to compute Xi\mathring{x}H_{iL} of each input channel (i) first, then add all results together, as illustrated in FIG. 1. The computation Xi\mathring{x}H_{iL} can be computed using block convolution based on FFT, as described by Alan V. Oppenheim, Ronald W. Schafer and John R. Buck, “Discrete-Time Signal Processing”, 2^{nd} edition, pp. 582-588, Prentice-Hall, New Jersey, 1999. Both overlap-add and overlap-save methods can be used. The overlap-add method is shown as an example. But, all analysis and results discussed hereinafter can be applied to the overlap-save method, as well.

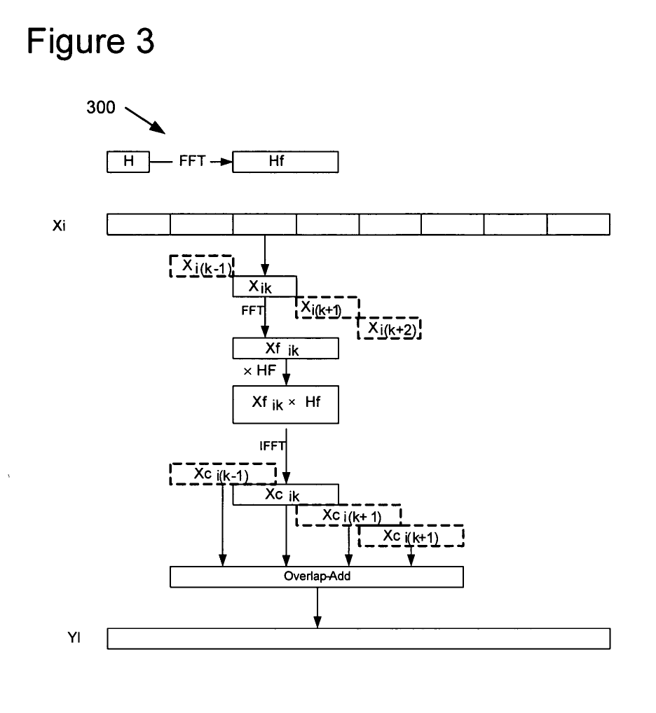

FIG. 3 shows the basic process flow of the overlap-add method. Suppose the length of the FIR filter is P. The overlap-add method first cuts the input signal (Xᵢ) into segments (Xᵢₖ) with length of L. Then, the FFT transform is applied on each segment. In alternative implementations, other transforms can be substituted in place of the FFT and its inverse for transforming the audio signal segments between the time domain and the frequency or other like transform domain. The FFT of each segment (Xfᵢₖ) is multiplied by the FFT of the FIR filter (Hf). The result is inverse FFT transformed into a time domain signal (Xcᵢₖ). The length (M) of the FFT transform should satisfy (N being the number of channels):
M≧N+P−1

The time domain signals from inverse FFT are shifted and overlapping added to construct Xi\mathring{x}H_{iL}. The shift amount between two adjacent segments is L.

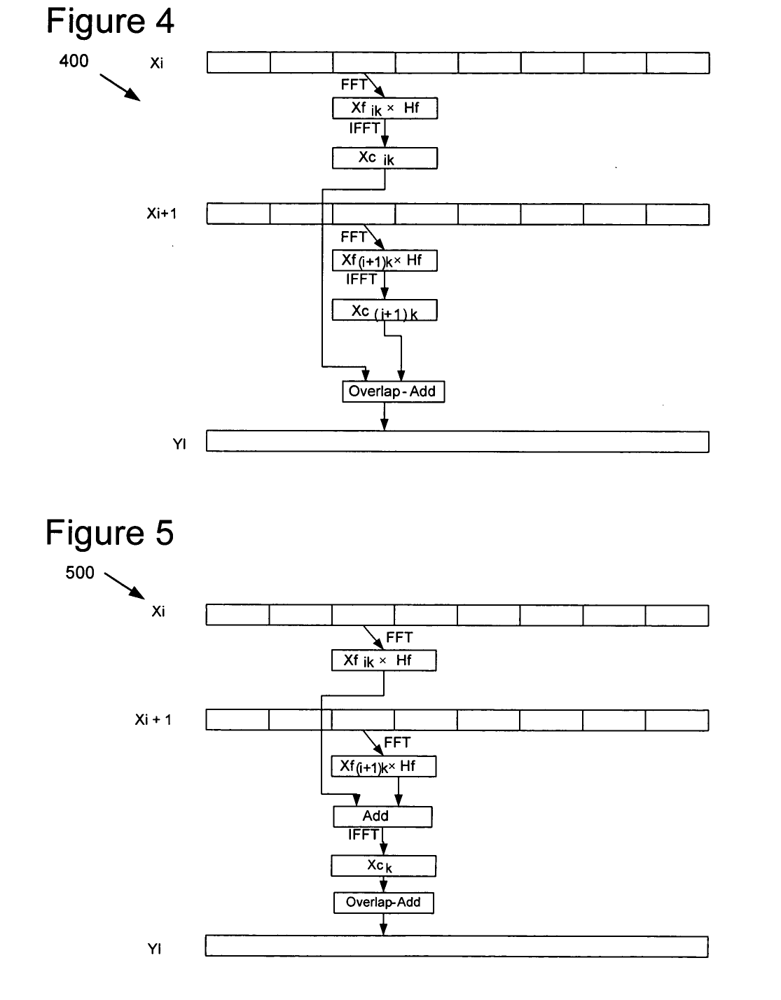

FIG. 4 illustrates a basic implementation of the overlap-add method in an N-to-1 system. For each segment of each input channel, one forward FFT and one inverse FFT are required. FIG. 4 illustrates the use of two input channels as an example, and the analysis can be extended to arbitrary number of inputs. As shown in FIG. 4, each segment in the first channel (Xᵢ) needs a forward FFT and an inverse FFT. Likewise, a forward FFT and inverse FFT is performed for each segment in the additional channel (Xᵢ₊ₗ). Therefore, for every segment of output, the illustrated 2-channel system needs 2 FFT and 2 IFFT. More generally, for an N to 1 system, N forward FFT and N inverse FFT are required to generate one segment of the output. Moreover, the headphone virtualization audio system 200 (FIG. 2) is actually two N to 1 systems (one for each ear's audio input). Accordingly, if this straightforward overlap-add method were used in the N-channel headphone virtualization audio system, then N*2 forward FFT and N*2 inverse FFT would be required for each L samples of the headphone audio output. There is a multiplication by 2 because the output to both the left ear and right ear need to be calculated. Moreover, because the number of channels in surround sound audio can be as large as 6 or 8, the total number of the FFT and IFFT transforms is still very large and makes the auralization computation very expensive.

2. Fast Headphone Virtualization

One improved, fast headphone virtualization technique 500 shown in FIG. 5 reduces the computation expense compared to the basic overlap-add method shown in FIG. 4. This fast headphone virtualization technique reduces the total number of the inverse FFT from N*2 to 2 for the complete headphone audio system 200 (FIG. 2). The fast headphone virtualization technique achieves this reduction by summing contributions from the N-channels to the respective left or right headphone audio input while in the frequency domain, prior to the inverse FFT transform. In the basic implementation 400 shown in FIG. 4, we notice that the results of the head-related transform for each channel (i.e., both Xfᵢₖ×Hf and Xf₍ᵢ₊ₗ₎ₖ×Hf) of the current segment go through the IFFT and a summation process to produce the respective headphone audio input. In this basic implementation, the IFFT is first performed for each channel's contribution, and the summation across channels for each ear is then performed in the time domain.

In this first fast headphone virtualization technique 500, a summation of the input channels' contributions for the respective ear is performed in the frequency domain, prior to the IFFT. More specifically, the results of the head-related transform for each channel (i.e., both Xfᵢₖ×Hf and Xf₍ᵢ₊ₗ₎ₖ×Hf) of the current segment are summed (in the “Add” stage). The IFFT of this sum is then performed to produce a time domain audio signal (X_{ck}) for the respective ear. The overlap add method can then be used to produce the headphone audio signal for the respective ear from the time domain audio signal segments (X_{ck}). By adding this summation of the input audio channel contributions at the frequency domain stage, only one IFFT needs to be performed for each ear—irrespective of the number N of input channels. In summary, the total number of the forward FFT remains N (for each ear) but only one inverse FFT. If we assume the forward FFT and inverse FFT have similar computational complexity, the fast headphone virtualization technique 500 saves about half of the computational complexity of the FFT (i.e., the basic implementation 400 uses 2·N FFTs and 2·N IFFTs, whereas the fast headphone virtualization technique 500 uses 2·N FFTs and only 2 IFFTs). This fast headphone virtualization technique is not limited in application to the headphone virtualization system 200, but can be applied to any N input 1 output linear time-invariant system.

In some alternative implementations, the length of the HRTF filter may be too large to be directly used in the overlap-add method, because it would consume a lot of time on memory swapping. In this case, the filter also can be divided into segments at the Xfᵢₖ×Hf stage. And the result of applying each filter segment are added together. Such a segmented HRTF filtering works well with the fast headphone virtualization technique.

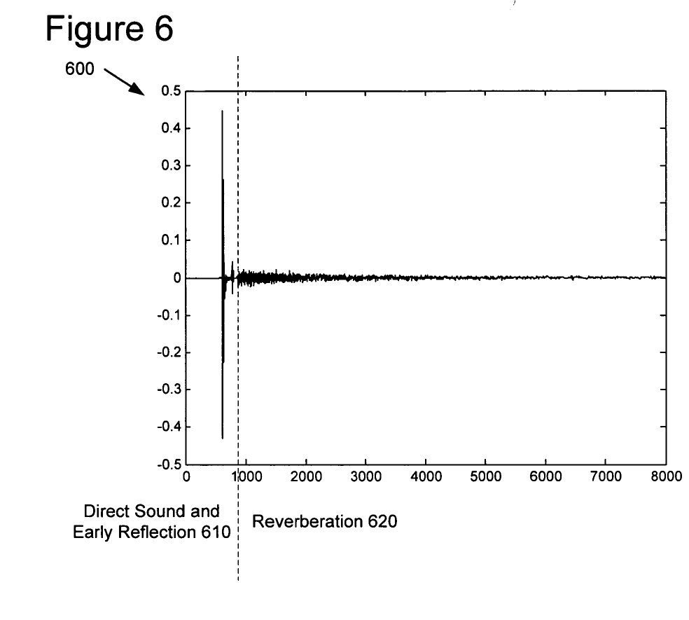

FIG. 6 shows the transfer response of a typical room filter H used to convert an input audio channel to each ear's headphone audio signal. This room filter consists of three parts: direct sound and early reflection (610), and reverberation (620). In headphone virtualization, in order to achieve a better externalization effect and give the listener a more realistic experience, the room filter H desirably includes not only the direct sound from the channel's speaker arriving at the ear (the initial “spike” at the left of the graph), but also includes early reflections of that sound in the room (the secondary “spike” following the initial “spike”) and reverberation (the decaying response following the direct sound and early reflection). The reverberation could be seconds longer. Though the method of cutting filters into segments mentioned in above paragraph can to a certain degree solve the problem of calculating a very long room filter H, a much more efficient implementation is still desired.

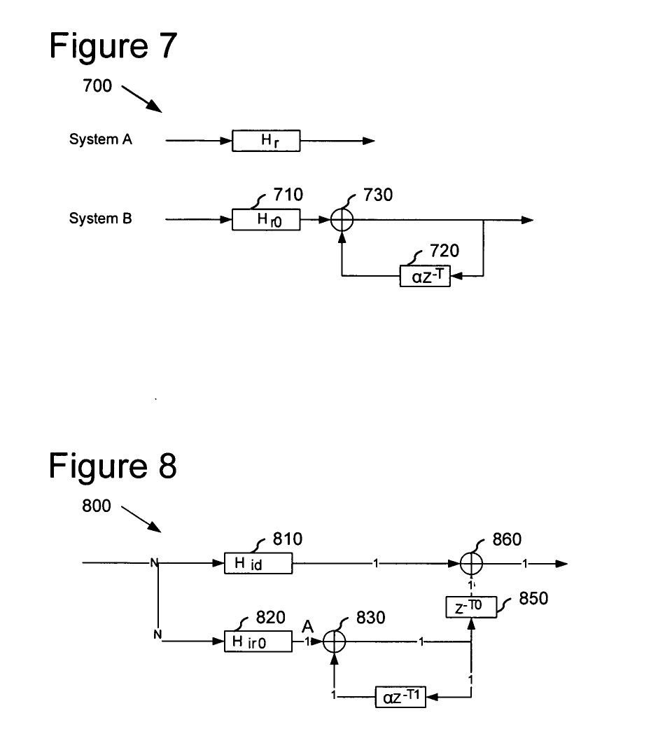

A further, second fast headphone virtualization technique addresses the problem posed by the very long length of room filter needed to represent the reverberation part (Hᵣ) of the room filter (H). This second fast headphone virtualization technique uses a very efficient hybrid FIR/IIR approach to implement a room filter with very long reverberation. In this hybrid FIR/IIR approach, the direct sound and early reflection 610 from the channel to the respective ear are modeled by HRTF filters (FIR filters). On the other hand, the reverberation 620 at the ear from the channel usually is an exponentially decayed all-pass sequence. It is all-pass because the reverberation is the result of diffuse reflection from random directions. As such, listeners should not have any directional feeling from the reverberation. The reverberation part of the room filter H by itself can be modeled as:
Hr(t)=S*exp(−(t/DS))

Where S is an all pass sequence and DS is the parameter to control the decay speed. Since reverberation is the result of many diffuse reflections from various directions, it is quite random and we can treat it as a random sequence. If we partition Hr into multiple fixed length segments Hri(t)=Hr(t+i*T), where t>0 and t<T, we can actually use a function of the preceding segment Hᵣᵢ*exp(−(T/DS)) to approximate subsequent segments Hᵣ₍ᵢ₊ₗ₎. One significant characteristic here is that the value, exp(−T/DS), is a constant, represented in FIG. 7 as α. A hybrid FIR/IIR approach used in system B (720) in FIG. 7 can then be used to approximate the reverberation part of the typical room filter (i.e., the Hᵣfilter in system A (710)). In this hybrid FIR/IIR approach, the reverberation portion of the room filter H is divided into reverberation filter segments. An initial reverberation filter segment (Hᵣ₀) 710 is applied to the audio signal of the channel. Subsequent segments 720 are then approximated by multiplying the result of the prior reverberation filter segment by the constant α. The value Z^{-T} represents delay corresponding to the length of the reverberation filter segment. The adder 730 then sums the current audio segment's initial reverberation segment with subsequent reverberation segments from past audio segments, which thus approximates the full length reverberation filter (Hᵣ) of system A. To further reduce the computation, we assume α has the same value in all H filters corresponding to one ear.

FIG. 8 shows the complete n-channel to one-channel system incorporating the hybrid FIR/IIR approach of FIG. 7. In this complete system, the reverberation filter is implemented independently from the direct sound and early reflection part of the room filter. Accordingly, the system first separates the room filter Hᵢ into two parts: the first part H_{d} is direct sound and early reflection, and the second part Hᵢᵣ is the reverberation. The H_{id} filter 810 is T₀ in length and it is implemented by using the first fast headphone virtualization technique 500 illustrated in FIG. 5, and the reverberation part is implemented by using the system B illustrated in 7. Each reverberation filter segment (Hᵢᵣ₀) is T₁long. Both the direct sound (H_{id}) filter 810 and initial reverberation (Hᵢᵣ₀) filter 820 can each be implemented using the first fast virtualization technique 500 shown in FIG. 5. These H_{id} and Hᵢᵣ₀ blocks thus take the N-channels of audio input to produce the direct part and initial reverberation part of the respective left or right headphone channel (at the outputs of the H_{id} and Hᵢᵣ₀ blocks, respectively). As discussed above, the adder 830 sums the initial reverberation of the current segment with subsequent reverberation filter segment results of preceding audio segments, which thus operates as the full length reverberation filter. Finally, the reverberation part is delayed at delay block 850 (by the length T₀ of the direct and early reflection part of the room filter) and added at adder 860 to the output of the direct and early reflection part to generate the final output of the n-to-1 system.

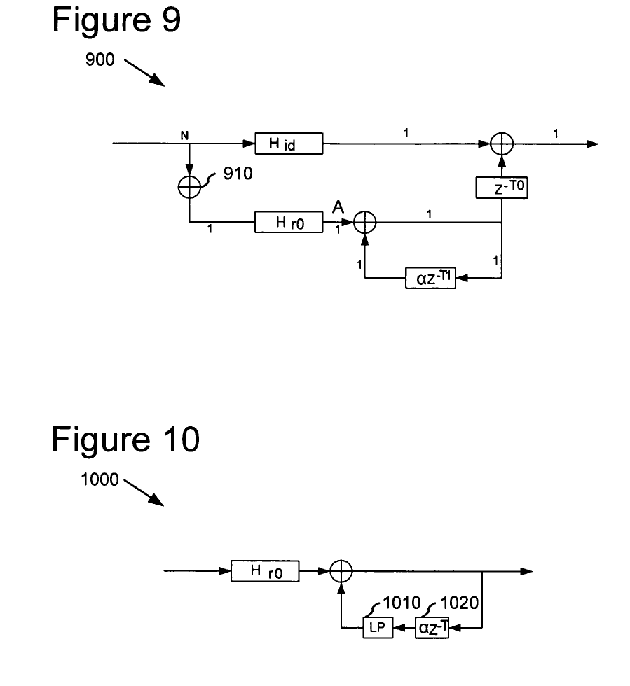

FIG. 9 illustrates a “post-reverb approach” variation of this complete headphone virtualization system of FIG. 8. It should be noticed that at point A in each implementation, the signal is already in stereo format because α is constant in all H filters. Furthermore, if we make another assumption that all reverberation filters of one ear can approximate each other, we can further reduce the computation complexity by placing a summation (adder 910) before the initial reflection filter segment Hᵣ₀. This permits the reflection part of the N channels to be combined by first summing the audio segments of the N-channels at adder 910 prior to the hybrid FIR/IIR-based implementation of the reflection part. This is termed the “post-reverb approach” because reverb is added after the multi-channel signal is folded down to 1 channel.

In various implementations of the headphone virtualization system 200 (FIG. 2), a choice can be made of various combinations of the two above-described fast headphone virtualization techniques can be made. For example, whether or not to use the hybrid FIR/IIR approach for reverberation is optional. If the room filter H is not too long and the computer is powerful enough, the approach based on FIG. 5 is used solely in the implementation for better accuracy. Otherwise, the system implementation variations in FIG. 8 or 9 can be chosen. Thus, headphone virtualization software may provide implementations based on both FIG. 5 and FIG. 8 or 9, and select which implementation is used based on the processing hardware on which it is installed and/or used.

FIG. 10 illustrates a further variation of the hybrid FIR/IIR reverberation filter approach of FIG. 7 that further provides warmth control. The hybrid FIR/IIR approach illustrated in FIG. 7 is based on an assumption that the reverberation filter is the exponential weighted all-pass sequence. But, in the real world, it is preferable to have a warmth effect in the reverberation. The warmth effect means that in the reverberation the decay of high frequency part is faster than that of the low frequency part. If the reverberation part is included in the room filter (e.g., as a long FIR filter) in the system 500 of FIG. 5, such a warmth effect can be realized by the long FIR filter itself. However, the hybrid FIR/IIR filter approach as illustrated in FIG. 7 applies the decay equally to low and high frequencies. The variation shown in FIG. 10 addresses this warmth effect problem by inserting a low pass filter 1010 in the hybrid FIR/IIR system. This low pass filter can be placed before or after the (αZ^{-T}) block 1020. By tuning the frequency response of the low pass filter, the warmth of the reverberation can be controlled to have the desired warmth effect.

3. Computing Environment

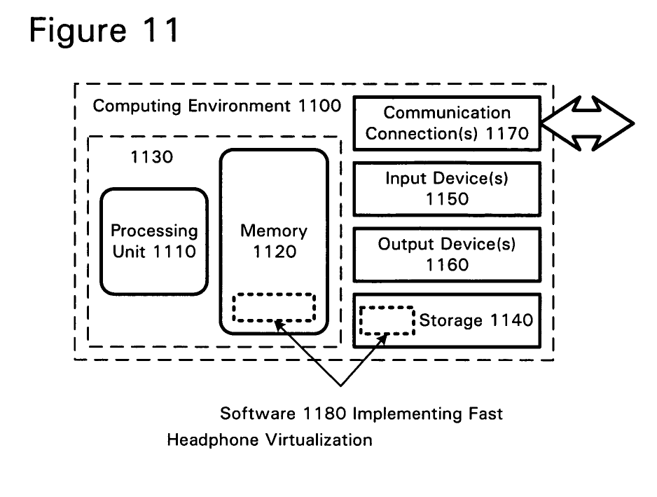

The above described headphone virtualization system 200 (FIG. 2) and fast headphone virtualization techniques can be implemented on any of a variety of devices in which audio signal processing is performed, including among other examples, computers; audio playing, transmission and receiving equipment; portable audio players; audio conferencing; Web audio streaming applications; and etc. The fast headphone virtualization techniques can be implemented in hardware circuitry (e.g., in circuitry of an ASIC, FPGA, etc.), as well as in audio processing software executing within a computer or other computing environment (whether executed on the central processing unit (CPU), or digital signal processor, audio card or like), such as shown in FIG. 11.

FIG. 11 illustrates a generalized example of a suitable computing environment (1100) in which the described headphone virtualization system 200 may be implemented. The computing environment (1100) is not intended to suggest any limitation as to scope of use or functionality of the invention, as the present invention may be implemented in diverse general-purpose or special-purpose computing environments.

With reference to FIG. 2, the computing environment (1100) includes at least one processing unit (1110) and memory (1120). In FIG. 2, this most basic configuration (1130) is included within a dashed line. The processing unit (1110) executes computer-executable instructions and may be a real or a virtual processor. In a multi-processing system, multiple processing units execute computer-executable instructions to increase processing power. The memory (1120) may be volatile memory (e.g., registers, cache, RAM), non-volatile memory (e.g., ROM, EEPROM, flash memory, etc.), or some combination of the two. The memory (1120) stores software (1180) implementing the described fast headphone virtualization techniques.

A computing environment may have additional features. For example, the computing environment (1100) includes storage (1140), one or more input devices (1150), one or more output devices (1160), and one or more communication connections (1170). An interconnection mechanism (not shown) such as a bus, controller, or network interconnects the components of the computing environment (1100). Typically, operating system software (not shown) provides an operating environment for other software executing in the computing environment (1100), and coordinates activities of the components of the computing environment (1100).

The storage (1140) may be removable or non-removable, and includes magnetic disks, magnetic tapes or cassettes, CD-ROMs, CD-RWs, DVDs, or any other medium which can be used to store information and which can be accessed within the computing environment (1100). The storage (1140) stores instructions for the software (1180) implementing the headphone virtualization system 200 using the fast headphone virtualization techniques.

The input device(s) (1150) may be a touch input device such as a keyboard, mouse, pen, or trackball, a voice input device, a scanning device, or another device that provides input to the computing environment (1100). For audio, the input device(s) (1150) may be a sound card or similar device that accepts audio input in analog or digital form, or a CD-ROM reader that provides audio samples to the computing environment. The output device(s) (1160) may be a display, printer, speaker, CD-writer, or another device that provides output from the computing environment (1100).

The communication connection(s) (1170) enable communication over a communication medium to another computing entity. The communication medium conveys information such as computer-executable instructions, compressed audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The fast headphone virtualization techniques herein can be described in the general context of computer-readable media. Computer-readable media are any available media that can be accessed within a computing environment. By way of example, and not limitation, with the computing environment (1100), computer-readable media include memory (1120), storage (1140), communication media, and combinations of any of the above.

The fast headphone virtualization techniques herein can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment.

For the sake of presentation, the detailed description uses terms like “determine,” “generate,” “adjust,” and “apply” to describe computer operations in a computing environment. These terms are high-level abstractions for operations performed by a computer, and should not be confused with acts performed by a human being. The actual computer operations corresponding to these terms vary depending on implementation.

In view of the many possible embodiments to which the principles of our invention may be applied, we claim as our invention all such embodiments as may come within the scope and spirit of the following claims and equivalents thereto.

1. An N-to-one channel audio signal processing method, comprising:
partitioning the n-channels of the audio signal into segments;
for a current segment of the n-channels,
performing a domain transform on the current segment in each of the n-channels to effect conversion to a transform domain;
applying a transfer function for each of the n-channels to the respective channels' current segment in the transform domain;
summing the transfer function results; and
performing an inverse of the domain transform on the sum of the transfer function results.

2. The N-to-one channel audio signal processing method of claim 1, further comprising:
performing an overlap-add of the results from a sequence of multiple segments.

3. The N-to-one channel audio signal processing method of claim 1, wherein the transfer function of each channel is a head-related transfer function defining a relationship between a multi-channel audio signal speaker in a room and a headphone input.

4. The N-to-one channel audio signal processing method of claim 1, further comprising:
performing the signal processing of the current segment of the n-channels for both a direct sound/early reflection part and an initial reverberation part of the transfer function;
subject to a delay corresponding to a length of the initial reverberation part of the transfer function, first summing the result of performing the signal processing of the current segment for the initial reverberation part together with that of prior segments scaled by a constant decay value; and
second summing the result of performing the signal processing of the current segment for the direct sound/early reflection part together with results of the first summing subject to a delay corresponding to a length of the segments.

5. The N-to-one channel audio signal processing method of claim 4, further comprising:
together with scaling by the constant delay value, low-pass filtering the result of performing the signal processing of prior segments for the initial reverberation part.

6. The N-to-one channel audio signal processing method of claim 1, further comprising:
performing the signal processing of the current segment of the n-channels for a direct sound/early reflection part of the transfer function;
summing the current segment of the n-channels;
applying an initial reverberation part of the transfer function to the summed current segment of the n-channels;
subject to a delay corresponding to a length of the initial reverberation part of the transfer function, further summing the result of applying the initial reverberation part of the transfer function to the current segment together with that of prior segments scaled by a constant decay value; and
summing the result of performing the signal processing of the current segment for the direct sound/early reflection part together with results of the further summing subject to a delay corresponding to a length of the segments.

7. The N-to-one channel audio signal processing method of claim 6, further comprising:
together with scaling by the constant delay value, low-pass filtering the result of performing the signal processing of prior segments for the initial reverberation part.

8. An audio signal processing method, comprising:
partitioning an audio signal into audio signal segments;
for a current segment of the audio signal, applying a portion of a transfer function to the current segment, which portion represents an initial period of reverberation; and
summing the result of applying the transfer function portion to the current segment with the summed result for prior segments attenuated by a decay factor and subject to a delay corresponding to a length of the initial reverberation period.

9. The audio signal processing method of claim 8, further comprising:
further low pass filtering the attenuated, delayed and summed result for prior segments that is summed with the result of applying the transfer function portion to the current segment.

10. A fast headphone virtualization system, comprising:
an input for a n-channel audio signal;
a headphone virtualizer for converting the n-channel audio signal to a two-channel headphone audio signal, the headphone virtualizer comprising:
an audio signal segmenter for segmenting the n-channel audio signal;
a domain transformer for performing a domain transform of a current segment of the n-channel audio signal into a transform domain;
a room filter for applying respective head-related transfer functions of the n-channels to the current segment of the n-channel audio signal in the transform domain;
an adder for summing the transfer function results of the n-channels in the transform domain; and
an inverse domain transformer for inverse transforming the summed transfer function results to produce each channel of a headphone audio signal; and
a headphone audio signal output.

11. The fast headphone virtualization system of claim 10, wherein the headphone virtualizer further comprises:
a reverberation filter for applying a reverberation transfer function to the current segment of the n-channel audio signal to produce an initial reverberation signal segment for an initial reverberation period resulting at a delay from the current segment; and
a loop adder for summing the initial reverberation signal segment with a decaying reverberation signal segment from prior n-channel audio signal segments;
an attenuator for multiplying the sum output of the loop adder by a constant scaling factor to produce the decaying reverberation signal segment from prior n-channel audio signal segments; and
an output adder for summing the sum output of the loop adder at a reverberation delay together with a direct sound portion of a channel of the headphone audio signal to thereby add reverberation to the headphone audio signal channel.

12. The fast headphone virtualization system of claim 11, wherein the reverberation filter comprises:
a reverberation portion room filter for applying respective reverberation portion head-related transfer functions of the n-channels to the current segment of the n-channel audio signal in the transform domain;
an adder for summing the reverberation portion transfer function results of the n-channels in the transform domain; and
an inverse domain transformer for inverse transforming the summed reverberation portion transfer function results to produce the initial reverberation signal segment.

13. The fast headphone virtualization system of claim 11, wherein the reverberation filter comprises:
an adder for summing together the current segment of the n-channel audio signal; and
a reverberation portion room filter for applying a reverberation portion transfer function to the sum of the current segment of the n-channel audio signal to produce the initial reverberation signal segment.

14. The fast headphone virtualization system of claim 11, wherein the headphone virtualizer further comprises:
a low pass filter for filtering the decaying reverberation signal segment from prior n-channel audio signal segments to effect warmth control.

15. A software program code-carrying medium for carrying programming executable on a processor to provide fast headphone virtualization of an n-channel digital audio signal, the programming comprising:
code means executable on the processor for partitioning the n-channels of the digital audio signal into segments;
code means executable on the processor for performing a domain transform on a current segment in each of the n-channels to effect conversion to a transform domain;
code means executable on the processor for applying a transfer function for each of the n-channels to the respective channels' current segment in the transform domain;
code means executable on the processor for summing the transfer function results; and
code means executable on the processor for performing an inverse of the domain transform on the sum of the transfer function results.

16. The software program code-carrying medium of claim 15, wherein the programming further comprises:
code means executable on the processor for performing an overlap-add of the results from a sequence of multiple segments.

17. The software program code-carrying medium of claim 15, wherein the transfer function of each channel is a head-related transfer function defining a relationship between a multi-channel audio signal speaker in a room and a headphone input.

18. The software program code-carrying medium of claim 15, wherein the programming further comprises:
code means executable on the processor for performing the signal processing of the current segment of the n-channels for both a direct sound/early reflection part and an initial reverberation part of the transfer function;
code means executable on the processor for, subject to a delay corresponding to a length of the initial reverberation part of the transfer function, first summing the result of performing the signal processing of the current segment for the initial reverberation part together with that of prior segments scaled by a constant decay value; and
code means executable on the processor for second summing the result of performing the signal processing of the current segment for the direct sound/early reflection part together with results of the first summing subject to a delay corresponding to a length of the segments.

19. The software program code-carrying medium of claim 18, wherein the programming further comprises:
code means executable on the processor for, together with scaling by the constant delay value, low-pass filtering the result of performing the signal processing of prior segments for the initial reverberation part.

20. The software program code-carrying medium of claim 15, wherein the programming further comprises:
code means executable on the processor for performing the signal processing of the current segment of the n-channels for a direct sound/early reflection part of the transfer function;
code means executable on the processor for summing the current segment of the n-channels;
code means executable on the processor for applying an initial reverberation part of the transfer function to the summed current segment of the n-channels;
code means executable on the processor for, subject to a delay corresponding to a length of the initial reverberation part of the transfer function, further summing the result of applying the initial reverberation part of the transfer function to the current segment together with that of prior segments scaled by a constant decay value; and
code means executable on the processor for summing the result of performing the signal processing of the current segment for the direct sound/early reflection part together with results of the further summing subject to a delay corresponding to a length of the segments.

21. The software program code-carrying medium of claim 20, further comprising:
code means executable on the processor for, together with scaling by the constant delay value, low-pass filtering the result of performing the signal processing of prior segments for the initial reverberation part.

22. A software program code-carrying medium for carrying programming executable on a processor to provide fast headphone virtualization of an n-channel digital audio signal, the programming comprising:
code means executable on the processor for partitioning the audio signal into audio signal segments;
code means executable on the processor for applying a portion of a transfer function to a current segment of the audio signal segments, which portion represents an initial period of reverberation; and
code means executable on the processor for summing the result of applying the transfer function portion to the current segment with the summed result for prior segments attenuated by a decay factor and subject to a delay corresponding to a length of the initial reverberation period.

23. The software program code-carrying medium of claim 22, wherein the programming further comprises:
code means executable on the processor for further low pass filtering the attenuated, delayed and summed result for prior segments that is summed with the result of applying the transfer function portion to the current segment.
